(19) United States
(12) Patent Application Publication
(10) Pub. No.: US 2007/0026818 A1
(43) Pub. Date: Feb. 1, 2007

(54) Signal detection arrangement

(76) Inventors: Bruce A. Willins, East Northport, NY (US); Huayan Amy Wang, Hauppauge, NY (US); Benjamin Bekritsky, Hollis, NY (US)

Correspondence Address: FAY KAPLUN & MARCIN, LLP, 15O BROADWAY, SUITE 702, NEW YORK, NY, 10038, US

(21) Appl. No.: 11/193,665

(22) Filed: Jul. 29, 2005

(51) Int. Cl. H04B 1/02

(52) U.S. Cl. 455/91

(57) ABSTRACT

Described is an arrangement including a receiver and an enveloped detection arrangement. The receiver receives radio frequency signals generated according to a predetermined wireless communication protocol. The envelope detection arrangement screens the radio frequency signals for a predetermined signal which utilizes the predetermined wireless communication protocol and has a predetermined envelope sequence. Upon detection of the predetermined signal, the arrangement transmits a further signal to a computing device coupled thereto. The further signal is an instruction for the computing device to execute a predetermined action.

### INCORPORATION BY REFERENCE

The entire disclosure of U.S. Patent Appln. entitled “System and Method for Resilient Coverage in Wireless Networks” filed May 24, 2004, naming Bruce A. Willins, Huayan Amy Wang and Benjamin Bekritsky as inventors, is incorporated, in its entirety, herein.

### BACKGROUND

Wireless local area networks (“WLANs”) are frequently utilized in locations where one or more mobile units (“MUs”) (e.g., PDAs, scanners, laptops, cell phones, etc.) require access to the WLAN, a central server and/or a database. For example, in a retail or a warehouse environment, a plurality of MUs may be used at any one time to perform routine functions, such as retrieving data from inventory items (e.g., scanning barcodes, interrogating RFID tags). These MUs are connected to the WLAN via an access point (“AP”) in order to transmit the data to the central server, the database or other MUs. In the retail environment, the data may represent, for example, a number of items presently on a shelf, a location of an item within a store, etc.

These environments (e.g., retail, warehouse) may have highly dynamic radio frequency (“RF”) characteristics due to certain contingencies, such as floor plan changes and the addition, removal or movement of goods therein. RF surveys performed prior to and during the WLAN installation cannot cover all of these contingencies, and maintain a cost- and capacity-efficient WLAN architecture. That is, these contingencies may cause interruptions and interference in the wireless connections between the MUs and the APs resulting in coverage gaps in the WLAN. As a result, WLAN operators are forced to perform routine maintenance, including identifying and fixing the coverage gaps, which may represent significant time and cost to a proprietor of the WLAN (e.g., owner of a retail outlet).

To maintain reliability of the WLAN, the operators typically oversubscribe through proliferation of APs within the WLAN. However, each additional AP represents significant costs in terms of installation, maintenance, etc. Furthermore, the coverage gaps may be temporally-based, and, thus, not require full deployment (e.g., cabling, line/battery powering, etc.) of an additional AP. Thus, there is a need for a system which will maintain reliability and resiliency of the WLAN at a lower cost than the over-proliferation of APs therein.

### SUMMARY OF THE INVENTION

The present invention relates to an arrangement including a receiver and an enveloped detection arrangement. The receiver receives radio frequency signals generated according to a predetermined wireless communication protocol. The envelope detection arrangement screens the radio frequency signals for a predetermined signal which utilizes the predetermined wireless communication protocol and has a predetermined envelope sequence. Upon detection of the predetermined signal, the arrangement transmits a further signal to a computing device coupled thereto. The further signal is an instruction for the computing device to execute a predetermined action.

### BRIEF DESCRIPTION OF THE DRAWINGS

FIG. 1 shows an exemplary embodiment of a signal detection arrangement coupled to a wireless device according to the present invention;

FIG. 2 shows an exemplary embodiment of a predetermined signal according to the present invention;

FIG. 3 shows an exemplary embodiment of a system according to the present invention;

FIG. 4 shows an exemplary embodiment of a method for connecting a device to a network according to the present invention;

FIG. 5 shows an exemplary embodiment of a method utilized by a device requiring connection to a network according to the present invention; and

FIG. 6 shows an exemplary embodiment of a modified access point according to the present invention.

### DETAILED DESCRIPTION

The present invention may be further understood with reference to the following description and the appended drawings, wherein like elements are referred to with the same reference numerals. The exemplary embodiment of the present invention describes a signal detection arrangement coupleable to a computing device. As will be described further below, when the signal detection arrangement detects a predetermined signal, it sends an instruction to the computing device to execute a predetermined action.

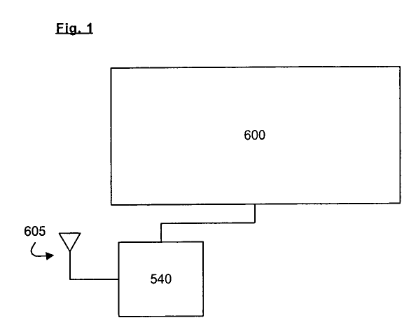

As shown in FIG. 1, in an exemplary embodiment, a signal detection arrangement (“SDA”) 540 may be manufactured as a stand-alone component for attachment to a computing device 600. In this embodiment, the SDA 540 may be a receiver including an amplifier and an envelope detection arrangement (e.g., AM demodulator, signal strength indicator). The SDA 540 may have its own power arrangement (e.g., a battery, line voltage, a solar cell) or may derive power from a power arrangement (e.g, battery, line voltage) of the device 600. The device 600 may be, for example, an access point (“AP”), a PC, a laptop, a cell phone, a PDA, a network interface card, a handheld computer, a barcode scanner, an RFID tag, etc. In this manner, the device 600 may have a port (e.g., serial, USB, etc.) or a lead which receives a cable/contact on the SDA 540. Also, the SDA 540 may include an antenna element 605 which may facilitate reception of radio frequency (“RF”) signal, as described further below. In another exemplary embodiment, the SDA 540 may be made integrally with the computing device 600. That is, the SDA 540 may be housed within the computing device 600 and connected to the other components thereof (e.g., a processor, a memory, a power arrangement, etc.)

The SDA 540 may have several further embodiments. In one exemplary embodiment, the SDA 540 is a low-power receiver (e.g., a non-802.11 radio) designed solely to respond to a predetermined signal 400, which will be described below. In another exemplary embodiment, the SDA 540 is a conventional receiver (e.g., a conventional 802.11 receiver). In yet a further embodiment, the SDA 540 is a modified receiver (e.g., reduced-power 802.11 receiver) which may be the conventional receiver with one or more modifications (e.g., decreased receivers sensitivity, single channel receiver operation, alternative demodulation schemes based on the predetermined signal 400, low duty cycle receiver operation, etc.). The one or more modifications preferably reduces battery power consumed by the SDA 540, thereby increasing a lifetime of the battery thereof or of the computing device 600.

Upon receipt of the predetermined signal 400, the SDA 540 may transmit a signal to the computing device 600 to execute a predetermined-action. In one exemplary embodiment, the signal is an instruction for the computing device 600 to switch from a first communication mode (“FCM”) to a second communication mode (“SCM”). In the FCM (e.g., a dormant state), the computing device 600 is powered off or in a low-power state conserving its battery. Thus, when the computing device 600 is in the FCM, only the SDA 540 may be powered. While in the FCM, the SDA 540 listens/screens the RF signals for the predetermined signal 400. In the SCM (e.g., active mode), the computing device 600 is capable of actively conducting wireless communications. When the predetermined signal 400 is received, the SDA 540 sends a signal to the computing device 600 indicating that it should switch to the SCM.

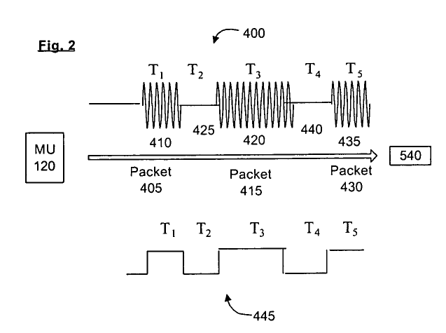

According to the present invention, the SDA 540 listens and/or screens RF signals for the predetermined signal 400 (e.g., a sequence of 802.11 transmissions, a predetermined signal strength (e.g., an RSSI)) which includes a predetermined envelope sequence, an exemplary embodiment of which is shown in FIG. 2 and described further below. The SDA 540 does not modify, decode and/or demodulate the predetermined signal 400. Thus, the SDA 540 detects the envelope sequences of the predetermined signal rather than extracting any data contained therein.

In this embodiment, the predetermined signal 400 may be generated by any wireless communication device utilizing a predetermined wireless communication protocol (e.g., an IEEE 802.11x standard). As shown in FIG. 2, the predetermined signal 400 may be a pulse-width-modulation sequence generated from one or more individual, sequential packet transmissions with a pre-defined spacing therebetween. The predetermined signal 400 may include a first packet 405 having a first predetermined pulse width 410 (e.g., T₁). A second packet 415 having a second predetermined pulse width 420 (e.g., T₃) may be separated from the first packet 405 by a first pre-defined space 425 (e.g., T₂). A third packet 430 having a third predetermined pulse width 435 (e.g., T₅) may be separated from the second packet 415 by a second pre-defined space 440 (e.g., T₄). As shown in FIG. 2, the predetermined pulse widths 410 and 435 may be the same and have a shorter duration than the second predetermined pulse width 420.

As understood by those of skill in the art, various embodiments of the predetermined signal 400 may be used in conjunction with the present invention. For example, one or more packets with uniform or varying pulse-widths, with or without uniform or varying spaces therebetween may be used. The representative example depicted in FIG. 2 is shown only to illustrate that the predetermined signal 400 may have a predefined structure(s) or characteristic(s) which is recognized by the SDA 540 as an indication that the device 600 coupled thereto should switch to the SCM.

As described above, the predetermined signal 400 may have a format including one or more packets of uniform or varying pulse-width. These packets may or may not contain any data. Thus, the SDA 540 may not attempt to decode the packets (e.g., demodulate the predetermined signal 400), but based on the predefined structure(s) (e.g., resolved on/off timing 445, the envelope sequence), determines that the transmission is the predetermined signal 400. This determination may be accomplished using, for example, a pulse code modulation (“PCM”) technique which may provide robust receiver sensitivity. In this manner, the predetermined signal 400 is operably similar to an SOS communication. Thus, the predetermined signal 400 may be utilized in an “emergency” scenario (e.g., critical that the computing device 600 switch to the SCM).

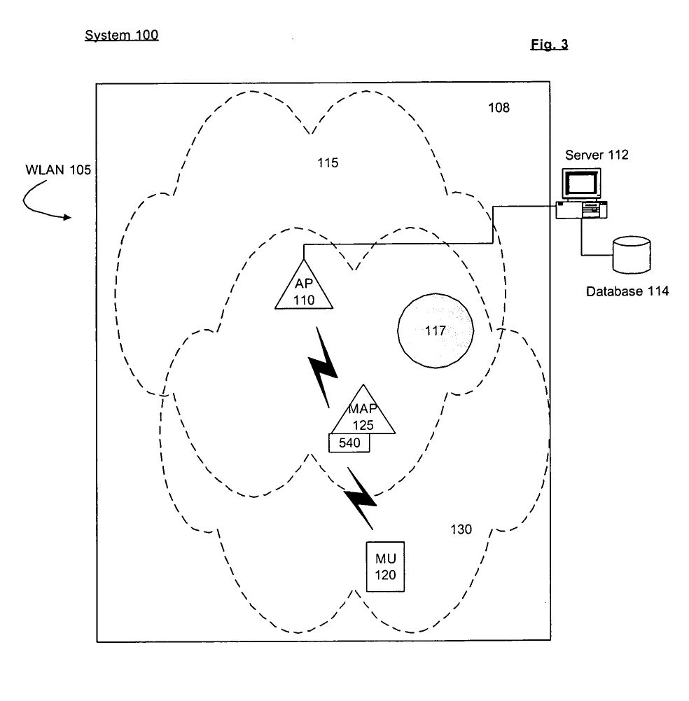

An exemplary use of the SDA 540 is described with reference to a system 100 shown in FIG. 3. The system 100 may include a wireless communication network (e.g., a wireless local area network (“WLAN”) 105) deployed within a space 108. The space 108 may be an enclosed environment (e.g., a retail location, a warehouse, a library, etc.), an open environment (e.g., a park) or a combination thereof. Although the system 100 will be described with reference to the WLAN 105, those of skill in the art will understand that the present invention may be utilized in any wireless communication network (e.g., WWAN, etc.) and/or by any device connected (wired or wirelessly) thereto.

The WLAN 105 may include a variety of wireless communication devices operating therein and connected thereto. For example, the WLAN 105 may include an access point (“AP”) 110 at a predetermined position within the space 108. That is, the position of the AP 110 may be determined as a result of, for example, a radio frequency (“RF”) survey conducted by an operator or a proprietor of the WLAN 105. The RF survey may have taken into account factors, such as a size of the space 108, wireless communication devices operable therein, applications of such devices, etc., and the positioning and/or configuration of the AP 110 may have been a function of the factors. As understood by those of skill in the art, the AP 110 may be one of a plurality of APs positioned within the WLAN 105, the space 108 and/or the system 100. Thus, any number of APs may be utilized in connection with the present invention.

The AP 110 may have a connection, wired (e.g., ethernet cable) or wireless, to a server 112. The server 112 may be further connected to a database 114, which may be integral with the server 112 or act as a stand-alone storage element. The server 112 may utilize a representation of the space 108 and/or the WLAN 105 and the position of the APs (including the AP 110) to determine an RF environment created thereby.

The AP 110 has a coverage area 115 in which it may conduct wireless communications with the wireless computing devices therein. The coverage area 115 may represent a predetermined range over which the AP 110 can send and receive RF signals. Although the coverage area 115 is depicted as uniform (e.g., fixed radius around the AP 110), those of skill in the art will understand that the coverage area 115 may be manipulated by, for example, beam steering or switching via a smart antenna at the AP 110. Although, FIG. 3 depicts that the AP 110 may communicate with any wireless device within the coverage area 115, those of skill in the art will understand that one or more coverage holes 117 may exist therein. The coverage hole 117 may be a region of any size in which wireless signals from the AP 110 cannot reach. The coverage hole 117 may be caused by, for example, obstructions in a signal path which prevent the signal from reaching the wireless device within the coverage hole 117. Those of skill in the art will further understand that the existence of the coverage hole 117 may be a function of time. That is, the coverage hole 117 may be eliminated (e.g., restored connectivity to the AP 110) upon one or more conditions (e.g., changing a physical environment around the AP 110).

As shown in FIG. 3, a mobile computing unit (“MU”) 120 is further included in the system 100. As understood by those of skill in the art, the MU 120 may be any computing unit with wireless communication capability (e.g., PDA, laptop, cell phone, handheld computer, network interface card, RFID tag, scanner, etc.). Without being in the coverage area 115 of the AP 110 (or any AP in the WLAN 105) or being within the coverage hole 117, the MU 120 is disconnected from the WLAN 105 and cannot communicate with any other MUs or APs connected thereto.

The disconnection may be a result of movement of the MU 120 within the space 108. For example, the MU 120 may be a scanner which is used for an inventory function (e.g., scanning barcodes) within a warehouse. After each scan or a predetermined number of scans, the MU 120 may transmit inventory data (e.g., product ID, location, etc.) to the server 112 via the AP 110. However, when the MU 120 is outside of the coverage area 115 of the AP 110, the transmission of the inventory data fails. Thus, a user of the MU 120 may attempt to reestablish connection to the WLAN 105 and complete the transmission by repositioning the MU 120 (and himself) within the warehouse. Alternatively, after the failed transmission, the MU 120 may store the inventory data and transmit it when a connection to the WLAN 105 has been reestablished (e.g., back inside the coverage area 115, out of the coverage hole 117, the coverage hole 117 has been eliminated). When the user is repositioning, the inventory function is suspended and no new inventory data is being collected. When the MU 120 transmits an increased amount of stored inventory data, it may use an increased portion of a bandwidth allocated to the WLAN 105. In both instances, the operator and/or the proprietor of the WLAN 105 is taking on significant costs as a result of the scanner being disconnected from the WLAN 105. Those of skill in the art will understand that the disconnection may be a result of factors other than position, such as, for example, decreased power of the AP 110 and/or the MU 120, barriers/obstructions between the MU 120 and the AP 110 which may create the coverage hole 117, etc.

Disconnections caused by movement, power and/or barriers/obstructions may be temporary. That is, as noted above, repositioning the MU 120 and/or time may resolve the disconnection. However, time taken to reposition and/or wait for restored connectivity may result in a loss in productivity. Thus, the present invention provides both temporary and permanent solutions for temporary and permanent disconnections suffered by MUs within the WLAN 105. In addition, these solutions may be low-cost in that significant hardware/software modifications and/or upgrades to the WLAN 105 and the devices therein/connected thereto may not be required.

According to this exemplary embodiment of the present invention, the system 100 further includes a modified AP (“MAP”) 125 positioned within the WLAN 105. Preferably, the MAP 125 is positioned within the coverage area 115 of the AP 110 allowing for wireless communication therebetween. The MAP 125 may be positioned during initial deployment of the WLAN 105 and/or as a result of, for example, coverage gap detection. Those of skill in the art will understand that any number of MAPs may be positioned within the WLAN 105. As will be described below, deployment and utilization of the MAPs may extend the RF environment and provide reliability and resiliency thereto. For example, the MAPs may allow the APs to communicate with MUs within coverage holes and/or outside of their respective coverage areas.

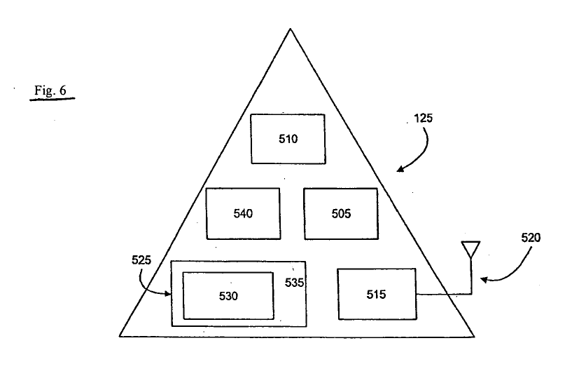

An exemplary embodiment of an architecture of the MAP 125 is shown in FIG. 6. The MAP 125 may include components similar to a conventional AP (e.g., AP 110). For example, the MAP 125 may include a processor 505, a memory arrangement 510 and one or more transceivers 515 interconnected in any known manner (e.g., via a bus). Each transceiver 515 may include an antenna element 520 attached thereto. When powered, the transceiver 515 is capable of conducting wireless communications within the WLAN 105. As will be explained further below, the MAP 125, when powered, provides for wireless communications on the same channel as the AP 110, thereby limiting co-channel and/or adjacent channel interference. Further included on the MAP 125 may be a LAN port (e.g., RJ 45), one or more light-emitting diodes (e.g., power, LAN connection, active, etc.) and a reset and/or power button/switch. According to the present invention, the MAP 125, the AP 110, the MU 120 and any other wireless computing device connected to the WLAN 105 may be capable of conducting wireless communications according to one or more predefined communication protocols (e.g., IEEE 802.11x).

The MAP 125 may further include a power arrangement 525. According to the present invention, the power arrangement 525 may be a battery 530 housed within a battery compartment 535 in the MAP 125. The battery compartment 535 may include a security feature (e.g., a lock) which would allow only authorized personnel to change/charge the battery 530. The MAP 125 may monitor a charge level of the battery 530 and transmit a signal to the server 112 (or broadcast a signal) when the level reaches a predetermined threshold, indicating that the battery 530 must be either replaced and/or recharged. In another embodiment, the battery 530 is attached to a recharger (not shown) which may be, for example, a solar cell. Thus, the battery 530 may recharge itself on a continuous basis. In a further embodiment, the power arrangement 525 is a line voltage.

According to the present invention, the MAP 125 may further include the SDA 540. In the exemplary embodiment shown in FIG. 6, the SDA 540 may be housed within the MAP 125 and be connected to the other components of the MAP 125 (e.g., processor 505, memory 510, transceiver 515, antenna element 520) so that the SDA 540 may draw power from either the power arrangement 525 of the MAP 125 or a further power arrangement (e.g., a battery) used only by the SDA 540. The SDA 540 preferably includes one or more modifications which allow for operation at a reduced power, as described above. The SDA 540 does not modify, decode and/or demodulate the predetermined signal 400. Thus, the present invention is directed to recognition of the envelope of the predetermined signal rather than any data contained therein. Those of skill in the art will understand that the SDA 540 may listen to an area broader than the further coverage area 130.

In this exemplary embodiment, the MAP 125 is not connected (e.g., wired) to the WLAN 105 via, for example, network infrastructure cabling (e.g., Ethernet cabling). Thus, with no cable connecting the WLAN 105 and the LAN port on the MAP 125, the MAP 125 may not directly initiate wireless communications and/or communicate with the server 112. Thus, the MAP 125 remains in an idle state until the predetermined signal 400 is transmitted/broadcast over a radio channel and received by the SDA 540, as further described below.

The MAP 125 switches between the FCM and the SCM upon receipt of the predetermined signal 400 by the SDA 540. Thus, the MAP 125 utilizes a dual-mode of operation including the FCM and the SCM. In the FCM, the MAP 125 is powered off or in a low-power state, conserving the battery 530. In the SCM, the MAP 125 is capable of actively conducting wireless communications.

When the predetermined signal 400 is received, the SDA 540 switches the MAP 125 from the FCM to the SCM. That is, the SDA 540 sends a signal to the processor 505 indicating that the MAP 125 should switch to the SCM. Once the MAP 125 has switched to the SCM, it acts as a bridge by, for example, receiving a signal (e.g., an 802.11 transmission) from the AP 110 and transmitting it to the MU 120, or vice-versa. Thus, the AP 110 may effectively extend the coverage area 115 to include a further coverage area 130 of the MAP 125. No hardware, software or power modifications need be made to the AP 110 which may communicate with the MU 120 (or any wireless device within the coverage area 130) via the MAP 125. Those of skill in the art will understand that the further coverage area 130 may have similar characteristics (e.g., size, space, dimension, etc.) to that of the coverage area 115.

Referring again to FIG. 3, in operation, the MU 120 may be located (temporarily or permanently) outside of the coverage area 115 or in the coverage hole 117, and, as a result, be disconnected from the WLAN 105. The MU 120 may be able to detect this disconnection. For example, the MU 120 may determine the disconnection as a predetermined number of missed beacons from the AP 110, an upper layer protocol timeout (e.g., TCP timeout) and/or one or more failed communication transactions (e.g., did not receive acknowledgment from AP 110). Preferably, the MU 120 detects the disconnection immediately or soon after its exit from the coverage area 115 or entrance into the coverage hole 117.

Upon detection of the disconnection, the MU 120 may attempt to reconnect to the AP 110 or any other AP connected to the WLAN 105. If this attempted reconnection fails, the MU 120 transmits the predetermined signal 400. As understood by those of skill in the art, the transmission of the predetermined signal 400 may not be transmitted to a particular wireless computing device, but may simply be a broadcast by the MU 120 over a radio channel. Further, transmission of the predetermined signal 400 may be user-controlled if, for example, the MU 120 detects the disconnection but the user desires to work offline (i.e., disconnected from the WLAN 105).

When the MU 120 detects the disconnection from the WLAN 105, it transmits/broadcasts the predetermined signal 400 in an attempt to reestablish the connection. The predetermined signal 400 is received by the SDA 540 which is connected to the MAP 125. In one exemplary embodiment, the SDA 540 only responds to a transmission of the predetermined signal 400. That is, the SDA 540 does not respond to any signals (e.g., 802.11 transmissions, non-802.11 transmissions, etc.) other than the predetermined signal 400. Thus, the SDA 540 may consume very little power from its power source or that of the MAP 125.

Upon receipt of the predetermined signal 400, the SDA 540 indicates to the MAP 125 that it should switch from the FCM to the SCM. In the SCM, the MAP 125 may relay transmissions (e.g., 802.11 packets) from the MU 130 to the AP 110, and vice-versa. For example, once the MAP 125 enters the second mode, it may transmit a beacon from the AP 110 to the MU 120. When the MU 120 receives the beacon, it will know that it has been (re)connected to the WLAN 105. The MAP 125 may remain in the SCM until a predetermined condition occurs. For example, the predetermined condition may be when no MUs are associated with the MAP 125. As will be understood by those of skill in the art, when the MAP 125 is in the SCM, the SDA 540 may cease listening for the predetermined signal 400. That is, the SDA 540 may not require power while the MAP 125 is in the SCM. Thus, when the MAP 125 is in the FCM, the SDA 540 is powered and the MAP 125 is not, and when the MAP 125 is in the SCM, the MAP 125 is powered and the SDA 540 may not be powered.

In a further embodiment of the present invention, after the MAP 125 switches from the FCM to the SCM, it transmits a notification signal to the server 112 via the AP 110. The notification signal may alert the server 112 that the MAP 125 has been activated (e.g., switched to the SCM) indicating a coverage gap within the WLAN 105. As understood by those of skill in the art, the notification signal may include data such as, for example, an identification and a location of the MAP 125 and a time of receipt of the predetermined signal 400. The data may further include an identification of the device from which it was transmitted (e.g., the MU 120). The data may be utilized by the server 112 and/or operator/proprietor of the WLAN 105 to determine coverage gaps and intermittent outage trends therein.

Upon receipt of the notification signal, the server 112 may instruct the MAP 125 to remain in the SCM thereby providing the connection to the WLAN 105 for the MU 120. In a further embodiment, the server 112 indicates to the operator/proprietor of the WLAN 105 that the MAP 125 is activated and will be so for a predetermined amount of time. In that time, the operator/proprietor may replace the MAP 125 with a conventional AP (e.g., with a wired or wireless connection to the WLAN 105). Alternatively, the server 112 may instruct one or more APs (e.g., AP 110) within a predetermined distance around the MAP 125 to increase power expanding a coverage thereof (e.g., coverage area 115). Those of skill in the art will understand that any of the above responses to the notification signal may temporarily or permanently establish a connection to the WLAN 105.

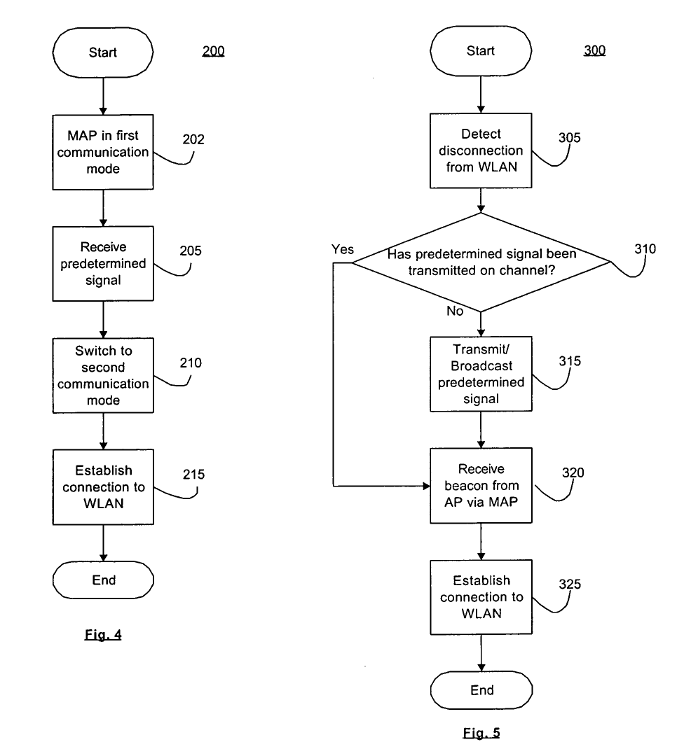

An exemplary embodiment of a method 200 according to the present invention is shown in FIG. 4. The method 200 may be implemented in hardware or software, and executed by the processor 505 in the MAP 125 and/or the SDA 540. In step 202, the MAP 125 is in the FCM. Thus, the SDA 540 is listening/screening wireless communications within the range thereof for the predetermined signal 400.

In step 205, the SDA 540 receives the predetermined signal 400. As described above, the predetermined signal 400 may be transmitted by the MU 120 in response to the disconnection from the WLAN 105 (e.g., exiting the coverage area 105, powering up outside the coverage area 105, in the coverage hole 117). In one exemplary embodiment, after receiving the predetermined signal 400, the SDA 540 switches to a power-off state. Thus, the SDA 540 and the MAP 125 are mutually exclusive, in that when one is powered, the other is not.

In further embodiments of the present invention, the predetermined signal 400 may be transmitted from other sources as a result of other conditions in the WLAN 105. For example, in one exemplary embodiment, the AP (e.g., AP 110, a further AP, a dumb access port) may transmit the predetermined signal 400 as a result of a predetermined event, such as, for example, an increased amount of communications which exceeds a capacity of the AP, if the AP detects a malfunction (e.g., wired connection ceases working), or if the AP requests assistance from the further AP (or any other wireless device) for a diagnostic of itself. The above examples of the predetermined event for transmission of the predetermined signal 400 are illustrative thereof, and those of skill in the art will understand that various other examples may be contemplated which remain within the scope of the present invention.

In step 210, the MAP 125 switches from the FCM to the SCM. As noted above, the MAP 125 may remain in the SCM until no MUs are associated therewith. While in the SCM, the MAP 125 is configured to relay transmissions between devices in the WLAN 105, particularly devices within the further coverage area 130 (e.g., MU 120 to AP 110, and vice-versa).

In step 215, the MAP 125 establishes the connection to the WLAN 105. In one embodiment, as described above, the MAP 125 may transmit the beacon received from the AP 110 to the MU 120, connecting the MU 120 to the WLAN 105. In a further embodiment, the MAP 125 transmits the notification signal to the server 112 via the AP 110. The notification signal, as stated above, may indicate that the coverage gap exists where the MU 120 is located. In yet a further embodiment, the predetermined signal 400 may have contained data. In this embodiment, the MAP 125 transmits the predetermined signal 400 to the AP 110, and, then, transmits beacons to the MU 110. In the cases where the AP 110, the further AP or the dumb access port transmitted the predetermined signal 400, the MAP 125, after switching to the SCM, may further operate as a conventional AP.

A further exemplary embodiment of a method 300 according to the present invention is shown in FIG. 5. The method 300 may be implemented in hardware or software, and executed by a processor in any device which requires the MAP 125 (or any device connected to the SDA 540) to switch to the SCM (e.g., due to disconnection from the WLAN 105, surge in traffic, malfunction, aided diagnostic, etc.). Although the method 300 will be described with reference to the MU 120, those of skill in the art would understand that the method 300 may be executed by any wireless device (e.g., AP, MU, etc.) with transmission capability.

In step 305, the MU 120 detects the disconnection from the WLAN 105 based on one or more predetermined criteria. For example, the criteria may be one or more missed beacons from the AP 110, one or more upper layer protocol timeouts (e.g., TCP timeouts), one or more failed transmissions, etc.

In step 310, the MU 120 determines whether the predetermined signal 400 has been previously broadcast on or transmitted over the radio channel. In this manner, the MU 120 may use an energy detection mechanism (e.g., one of a plurality of conventional clear channel assessment (“CCA”) modes) to detect energy in the channel. The MU 120 may detect the energy in the channel for a predetermined duration which is preferably long enough to determine if the predetermined signal 400 has been transmitted over or broadcast on the channel, or if the SDA 540 has received the predetermined signal 540. The use of the energy detection mechanism may prevent corruption of the predetermined signal 400 previously transmitted on the channel by preventing multiple MUs disconnected from the WLAN 105 from transmitting their own predetermined signal 400. As understood by those skilled in the art, detecting the in-channel energy may be optional for the MU 120. That is, once the MU 120 detects the disconnection, it may automatically transmit/broadcast the predetermined signal 400 without detecting the in-channel energy.

In step 315, the predetermined signal 400 has not been transmitted/broadcast on the channel, and, thus, the MU 120 transmits/broadcasts the predetermined signal 400. In one exemplary embodiment, the SDA 540 hears the predetermined signal 400, and the MAP 125 switches from the FCM to the SCM, which has been described above. In a further exemplary embodiment, it is possible that the MU 120 connects to the WLAN 105 via the AP 110 or the further AP. In this manner, the MU 120 may be moving within the space, lose the connection at a first position, and reestablish the connection at a second position. For example, the MU 120 may move to an area of the warehouse which is outside of the coverage area 115, thereby temporarily disconnecting from the WLAN 105 (e.g., in the coverage gap). However, the MU 120 may be in the coverage gap only temporarily and reconnect to the WLAN 105 via the further AP (e.g., conventional AP) within a short time. Thus, upon reconnecting to the WLAN 105 via the further AP, the MU 120 and/or the further AP may transmit a message to the server 112 indicating that the MU 120 has been reconnected and that the MAP 125 may remain in or switch back to the FCM. Therefore, the server 112 may distinguish between the coverage gaps in the WLAN 105 and/or adjust operation of the WLAN 105 accordingly (i.e., no chance of reconnection, low chance of reconnection, transient). For example, the coverage gap with ‘no chance of reconnection’ or ‘low chance of reconnection’ may warrant deployment of a conventional AP (wired or wireless) therein or may require that the MAP 125 remain in the SCM. Whereas, the ‘transient’ coverage gap may simply warrant a power adjustment (e.g., to manipulate a coverage area) of the AP in the WLAN 105.

In step 320, either the predetermined signal 400 has been previously transmitted/broadcast on the channel (step 310) or the MU 120 has transmitted/broadcast the predetermined signal 400 thereon (step 315). Thus, the MU 120 may receive the beacon from the AP 110 via the MAP 125, reestablishing the connection to the WLAN 105 (step 325). According to the present invention, the user of the MU 120 and/or the server 112 may be notified of the disconnection from and/or the connection to the WLAN 105. For example, while in the coverage area 115, the MU 120 may include a display/message which indicates that the MU 120 is connected to the WLAN 105. Furthermore, the server 112 may have knowledge of those devices (APs, MAPs, MUs, etc.) which are connected to the WLAN 105. Upon exiting from the coverage area 115 (or powering on in the coverage gap), the display/message may indicate a disconnection from the WLAN 105. As understood by those of skill in the art, the server 112 may recognize when a device previously connected to the WLAN 105 loses the connection (e.g., in the coverage gap, malfunction, etc.), but may not recognize the disconnection if the device (e.g., the MU 120) is powered on in the coverage gap.

After the MU 120 is connected to the WLAN 105, it may communicate with any devices connected thereto. For example, the MU 120 may transmit the inventory data to the AP 110 via the MAP 125. With a connection to the AP 110, the MU 120 may further communicate with the server 112 and further MUs connected to the WLAN 105. As described above, once the MAP 125 is in the SCM, it may simply retransmit received signals between wireless devices (e.g., MU 120 to AP 110, and vice-versa).

In a further exemplary embodiment of the present invention, the AP 110 may transmit the predetermined signal 400 to the SDA 540 attached to the MAP 125. In this manner, the AP 110 may attempt to expand the coverage area 115 to devices not previously therein. Those of skill in the art would understand that this embodiment may be useful for many applications, such as, for example asset tag (e.g., RFID tag) wakeup. That is, the AP 110 may interrogate the asset tag via the MAP 125. This embodiment may be initiated by the server 112, any AP or any MU.

As described above, those of skill in the art will understand that the SDA 540 may be coupled to any wireless device and is not limited to the MAP 125 or an AP. For example, in another embodiment, the SDA 540 may be coupled to a network interface card (“NIC”) in a computing terminal (e.g., laptop, PC). Thus, transmitting the predetermined signal 400 from a cell phone, a PDA or a barcode scanner, may cause the SDA 540 to switch the NIC from the FCM to the SCM. Thus, the NIC may instruct the terminal to power-on. In this embodiment, the SDA 540 is used for convenience and/or efficiency. For example, if a user of the barcode scanner ends a shift and intends to enter data on the terminal, the user may transmit the predetermined signal 400 to the NIC. When the user arrives at the terminal, there will be no time wasted in powering-on the terminal and data entry may begin seamlessly.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An arrangement, comprising:
a receiver receiving radio frequency signals generated according to a predetermined wireless communication protocol; and
an envelope detection arrangement screening the radio frequency signals for a predetermined signal utilizing the predetermined wireless communication protocol and having a predetermined envelope sequence,
wherein, upon detection of the predetermined signal, the arrangement transmits a further signal to a computing device coupled thereto, the further signal being an instruction for the computing device to execute a predetermined action.

2. The arrangement according to claim 1,- wherein the envelope detection arrangement is one of an AM demodulator and a signal strength indicator.

3. The arrangement according to claim 1, further comprising a power source.

4. The arrangement according to claim 3, wherein the power source is one of a battery and a solar cell.

5. The arrangement according to claim 1, wherein the computing device is one of an access point, an access port, a laptop, a cell phone, a PDA, a network interface card, a handheld computer, an image-based scanner, a laser-based scanner, an RFID reader and an RFID tag.

6. The arrangement according to claim 1, wherein the receiver utilizes at least one of (i) a predetermined sensitivity, (ii) a single channel, (iii) an predetermined demodulation scheme and (iv) a predetermined duty cycle.

7. The arrangement according to claim 1, wherein the predetermined action is a change from a first communication mode to a second communication mode.

8. The arrangement according to claim 7, wherein the computing device conducts communications only when in the second communication mode.

9. The arrangement according to claim 1, wherein the predetermined envelope sequence is one of (i) a predetermined sequence of packets, (ii) a predetermined signal strength and (iii) a pulse-width modulation sequence.

10. The arrangement according to claim 1, wherein the envelope detection arrangement utilizes a pulse code modulation technique to identify the predetermined signal.

11. The arrangement according to claim 1, wherein the predetermined wireless communication protocol is an IEEE 802.11 protocol.

12. A method, comprising:
receiving, by a receiver, radio frequency signals generated according to a predetermined wireless communication protocol;
screening, by an envelope detection arrangement coupled to the receiver, the radio frequency signals for a predetermined signal utilizing the predetermined wireless communication protocol and having a predetermined envelope sequence; and
when the arrangement detects the predetermined signal, transmitting, by the arrangement transmits, a further signal to a computing device coupled thereto, the further signal being an instruction for the computing device to execute a predetermined action.

13. The method according to claim 12, wherein the envelope detection arrangement is one of an AM demodulator and a signal strength indicator.

14. The method according to claim 12, wherein the predetermined wireless communication protocol is an IEEE 802.11 protocol.

15. The method according to claim 12, wherein the predetermined action is a change from a first communication mode to a second communication mode.

16. The method according to claim 15, wherein the computing device conducts communications only when in the second communication mode.

17. The method according to claim 16, further comprising:
generating, by a wireless device, the predetermined signal only when the wireless device failed to connect to the computing device which communicates with the wireless device according to the predetermined wireless communication protocol; and
transmitting, by the wireless device, the predetermined signal.

18. The method according to claim 17, further comprising:
when the computing device is in the second communication mode, the computing device acts as a wireless bridge between the wireless device and a further wireless device.

19. The method according to claim 18, further comprising:
when the wireless device directly connects to the further wireless device, switching the computing device from the second communication mode to the first communication mode.

20. A system, comprising:
a computing device; and
an arrangement coupled to the computing device, the arrangement including a receiver receiving radio frequency signals generated according to a predetermined wireless communication protocol, the arrangement including an envelope detection arrangement screening the radio frequency signals for a predetermined signal utilizing the predetermined wireless communication protocol and having a predetermined envelope sequence,
wherein, upon detection of the predetermined signal, the arrangement transmits a further signal to the computing device, the further signal being an instruction for the computing device to execute a predetermined action.

21. The system according to claim 20, wherein the predetermined action is a change from a first communication mode to a second communication mode.

22. The system according to claim 21, wherein the computing device conducts communications only when in the second communication mode.
